(19) United States
(12) Patent Application Publication
(10) Pub. No.: US 2008/0302977 A1
(43) Pub. Date: Dec. 11, 2008

(54) Light emitting module for producing a visible light by passive ultraviolet excitation

(75) Inventors: Pei-Chih Yao, Taipei County (TW); Wen-Huu Dow, Taipei (TW); Chi Wen Sun, Taipei (TW); Kai-Shyong Tsay, Taipei County (TW)

Correspondence Address: BACON & THOMAS, PLLC, 625 SLATERS LANE, FOURTH FLOOR, ALEXANDRIA, VA, 22314-1176, US

(73) Assignee: ACPA Energy Conversion Devices Co., Ltd., Taipei City (TW)

(21) Appl. No.: 12/076,145

(22) Filed: Mar. 14, 2008

(30) Foreign Application Priority Data
Jun. 6, 2007 (TW) 096209306

(51) Int. Cl. G01N 21/64

(52) U.S. Cl. 250/461.1; 313/503

(57) ABSTRACT

A light emitting module for producing a visible light by passive ultraviolet excitation includes an excitation light source member and at least one layer of wavelength modulation matrix. The excitation light source member produces an ultraviolet light with a specific wavelength range. The wavelength modulation matrix adopts an organic polymer as a carrier, and the carrier adds a composite material composed of an organic wavelength modulation material, a quantum dot luminescence color rendering modulation material and a nanoparticle brightness enhancement luminescence powder, and the composite material is cured and formed by coating, injection molding, thin film lamination, screen printing or thick film printing, so that when the wavelength modulation matrix is projected by an ultraviolet light beam emitted by the excitation light source member, a light including a visible light is produced.

### BACKGROUND OF THE INVENTION

1. Field of the Invention

The present invention relates to a light emitting module for producing a visible light by a passive ultraviolet excitation, and more particularly to a light emitting module that uses UV LED, sunlight or any other light source that can produce an ultraviolet light as an excitation light source member to produce a light at least including a visible light.

2. Description of the Related Art

In recent years, white-light light emitting diode (LED) is the most prosperous and eye-catching developing product in the world. White LED has the features of small volume, free of heat radiation, low electric power consumption, long life, and quick response, and thus white LEDs can overcome the drawbacks of traditional light sources such as halogen bulbs, etc. In the meantime, developed countries such as USA, Japan and European countries consider white LED as an important light source of the 21^{st} century based on the common understanding of energy saving and environmental protection.

At present, a light emitting diode emits white light mainly in three ways: one way is a single-chip type blue LED which emits white lights by adding a blue light to a yellow phosphor type luminescence powder or adding a phosphor type luminescence powder having three wavelengths of RGB to an ultraviolet light emitting diode (UV LED), and the other way is a multi-chip type LED that uses two or three complementary primitive colors as a mixed light to produce white light. If the method of the multi-chip type LED is used, it is necessary to control a number of factors. Since the driving voltage, light emission output, temperature and life expectancy of different LEDs vary, therefore a higher production cost is incurred. On the other hand, if the method of the single-chip type LED is used, only one element will be required, and the design of driving loops will become easier. Thus, manufacturers tend to use the method of the single-chip type LED for their research and development.

When the light emitting method of the single-chip type LED is used, a phosphor type luminescence powder is coated onto the surface of an LED chip, such that when the phosphor type luminescence powder is excited by a light beam emitted by the LED, a light beam with a different wavelength is excited and emitted. The excited light beam remained from an incomplete absorption of the light beam emitted from the LED as well as the excited light beam of the phosphor type luminescence powder are mixed to produce white light.

In the aforementioned method of producing white light, the luminescence powder is coated onto an LED or contacted directly with the LED, and an electric power is provide for driving the LED to produce a light source, such method requires further improvements.

### SUMMARY OF THE INVENTION

In view of the shortcomings of the prior art, the inventor of the present invention based on years of experience in the related industry to conduct extensive researches and experiments, and finally developed a light emitting module for producing a light at least including a visible light by passive ultraviolet excitation in accordance with the present invention.

Therefore, it is a primary objective of the present invention to maintain an appropriate distance between an excitation light source member and a wavelength modulation matrix with a wavelength conversion function.

Another objective of the present invention is to produce a visible light in an environment with an ultraviolet light by projecting the ultraviolet light onto a wavelength modulation matrix and exciting the wavelength modulation matrix to produce a visible light.

A further objective of the present invention is to provide a light source applied to equipments such as an illumination device and a backlight module.

To achieve the foregoing objectives, the present invention uses an organic polymer material as a carrier, and the carrier adds a composite material composed of an organic wavelength modulation material, a quantum dot luminescence color rendering modulation material and a nanoparticle phosphous brightness enhancement powder to form a wavelength modulation matrix by coating, injection molding, thin film lamination, screen printing, thick film printing, or mounting. An appropriate distance is maintained between the wavelength modulation matrix and the excitation light source member, such that when the wavelength modulation matrix receives an UV LED, sunlight or another light source that produces an ultraviolet light as an excitation light source member, the matrix will produce a light at least including a visible light.

The above and other objects, features and advantages of the present invention will become apparent from the following detailed description taken with the accompanying drawing.

### BRIEF DESCRIPTION OF THE DRAWINGS

FIG. 1 shows a cross-sectional view of a light emitting module using an UV LED as an excitation light source member in accordance with the present invention;

FIG. 2 shows a cross-sectional view of an assembly as depicted in FIG. 1;

FIG. 3 shows a cross-sectional exploded view of a light emitting module using an UV LED as an excitation light source member in accordance with another preferred embodiment of the present invention;

FIG. 4 shows a cross-sectional view of an assembly as depicted in FIG. 3;

FIG. 5 shows a cross-sectional exploded view of a light emitting module using an Ultraviolet light in an environment as an excitation light source member in accordance with the present invention;

FIG. 6 shows a cross-sectional exploded view of an arc shape wavelength modulation material as depicted in FIG. 5;

FIG. 7 shows a cross-sectional exploded view of a light emitting module using an ultraviolet light in an environment as an excitation light source member in accordance with another preferred embodiment of the present invention.

FIG. 8 shows a cross-sectional exploded view of an arc shape wavelength modulation material as depicted in FIG. 7;

### DETAILED DESCRIPTION OF THE PREFERRED EMBODIMENTS

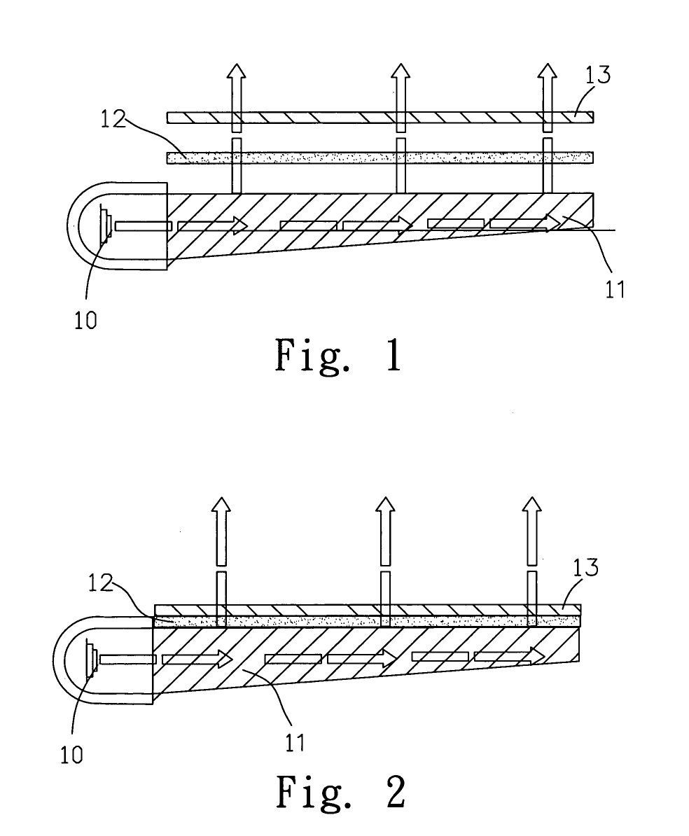

Referring to FIGS. 1 and 2 for a preferred embodiment of using an UV LED for producing an ultraviolet light as an excitation light source member, this method is applied to an illumination device or a backlight module, and the module includes an excitation light source member 10 (which is an UV LED in this embodiment and has a wavelength range of 360˜400 nm) and a light guide module 11 installed at a position proximate to the excitation light source member 10 for transmitting a light beam produced by the excitation light source member 10 to the outside (wherein an ultraviolet light produced by the excitation light source member is transmitted horizontally to the outside and resulted in a refraction at a specific angle in this embodiment), and the surface of the light guide module 11 includes at least one layer of wavelength modulation matrix 12, and the wavelength modulation matrix 12 uses an organic polymer as a carrier, and the carrier includes a composite material composed of an organic wavelength modulation material, a quantum dot luminescence color rendering modulation material and a nano particle size brightness enhancement luminescence powder. The organic polymer is a silicone, an optical polycarbonate (PC), an optical polymeric methyl methacrylate (PMMA) or an epoxy resin, and the organic wavelength modulation material is a light emitting fluorene oligomer, a light emitting homopolymer or a light emitting copolymer, and the quantum dot luminescence color rendering modulation material is a Group III/V semiconductor and a Group II/VI semiconductor (such as CdSe, PbSe, CdS, PbS, and core-shell quantum dots-CdSe/ZnS), and the nano particle size brightness enhancement luminescence powder is an oxide, a sulfide, a halogen calcium phosphate, a carbon,a diamond,an organic material and an inorganic material.

The mixed composite material is mounted (in the shape of a film layer, a bar, a sheet or a column) by coating, injection molding, thin film lamination, screen printing or thick film printing, or mounted directly onto the light guide module 11 by a screen printing or a thick film printing, and an optical lens device 13 for evenly diffusing or directionally modulating the light beam is coated or attached onto the wavelength modulation matrix 12.

The light guide module 11 and wavelength modulation matrix 12 could be made from the same materials and integrated.

When use, an electric power drives the excitation light source member 10 to produce an ultraviolet light beam, and the light guide module 11 projects the excited light beam produced by the excitation light source member 10 onto the wavelength modulation matrix 12 at a specific refraction angle. When the organic wavelength modulation material, the quantum dot luminescence color rendering modulation material and the nanoparticle brightness enhancement luminescence powder in the wavelength modulation matrix 12 receive the excited light beam produced by excitation light source member 10, a light at least including a visible light is formed.

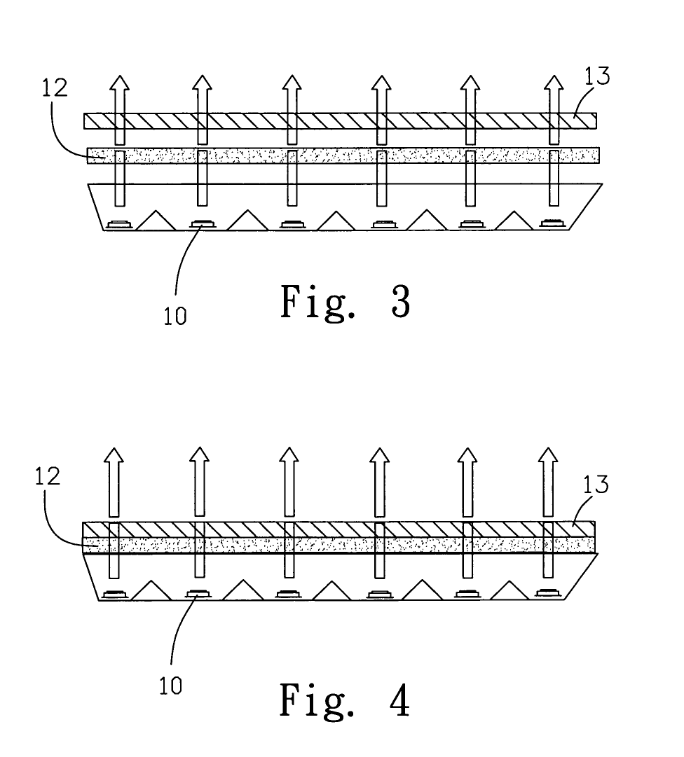

Referring to FIGS. 3 and 4 for another preferred embodiment of using an UV LED as an excitation light source and this method is applied to an illumination device or a backlight module, an ultraviolet light produced by the excitation light source member 10 is projected directly onto the wavelength modulation matrix 12, so that when the organic wavelength modulation material, the quantum dot luminescence color rendering modulation material and the nano particle size brightness enhancement luminescence powder in the wavelength modulation matrix 12 receive an excited light beam produced by the excitation light source member 10, a light at least including a visible light is formed.

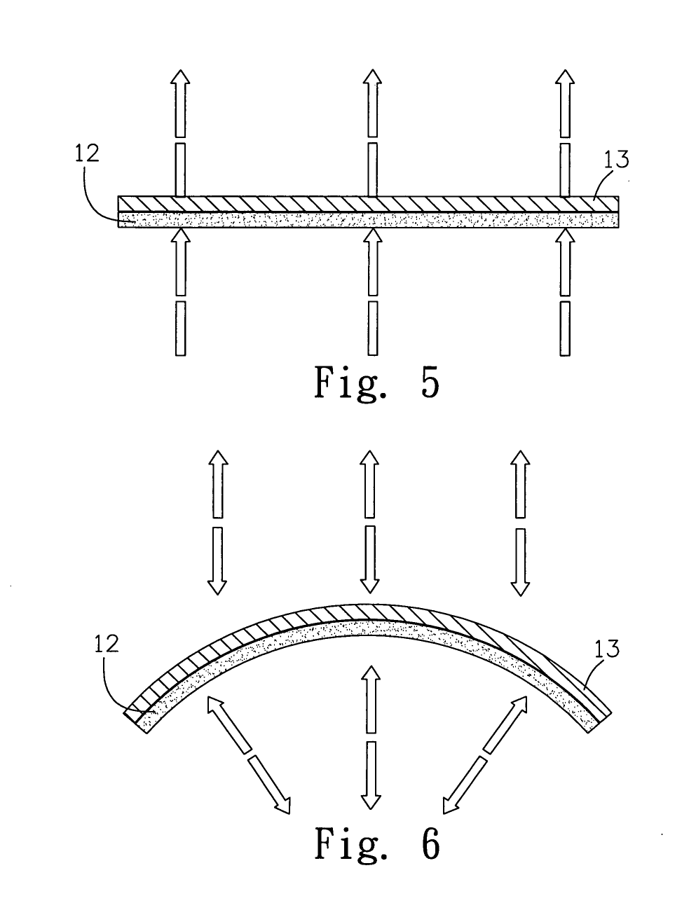

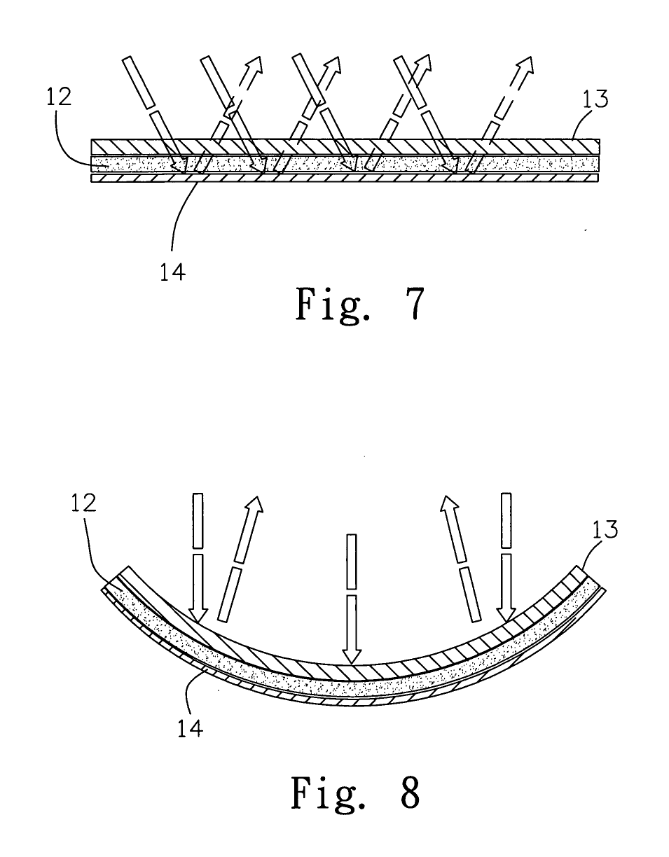

Referring to FIGS. 5, 6, 7 and 8 for a preferred embodiment of using other light source (such as sunlight) capable of emitting an ultraviolet light as an excitation light source member in accordance with the present invention, the ultraviolet light produced by the excitation light source member 10 (not shown in the figure) is projected directly onto the wavelength modulation matrix 12 (as shown in FIG. 5,6) or reflected by a reflector 14 installed on the wavelength modulation matrix 12 and in a direction opposite to the excitation light source member 10 (as shown in FIG. 7,8). When the organic wavelength modulation material, the quantum dot luminescence color rendering modulation material and the nano particle size brightness enhancement luminescence powder in the wavelength modulation matrix 12 receive the excited light beam of the excitation light source member 10, a light at least including a visible light is formed.

In summation of the description above, the article, shape, structure, apparatus of the present invention are novel and enhance over the prior art, and the invention complies with the requirements of patent application, and thus is duly filed for patent application.

While the invention has been described by means of specific embodiments, numerous modifications and variations could be made thereto by those skilled in the art without departing from the scope and spirit of the invention set forth in the claims.

What is claimed is:

1. A light emitting module for producing a visible light by passive ultraviolet excitation, comprising:
an excitation light source member, for producing an ultraviolet light with a specific wavelength range; and
at least one layer of wavelength modulation matrix, for maintaining an appropriate distance from said excitation light source member, and said wavelength modulation matrix being a carrier made of an organic polymer, and said carrier adding a composite material composed of an organic wavelength modulation material, a quantum dot luminescence color rendering modulation material and a nano particle size brightness enhancement luminescence powder, and said mixed composite material being mounted, deposited, cured and shaped; thereby, when said wavelength modulation matrix receives an ultraviolet light beam projected from said excitation light source member, a light at least including a visible light is emitted.

2. The light emitting module for producing a visible light by passive ultraviolet excitation according to claim 1, wherein said light whose wavelength range is at least from 360 nm to 400 nm.

3. The light emitting module for producing a visible light by passive ultraviolet excitation according to claim 1, wherein said excitation light source member is an ultraviolet light emitting diode (UV LED).

4. The light emitting module for producing a visible light by passive ultraviolet excitation according to claim 1, wherein said excitation light source member is sunlight.

5. The light emitting module for producing a visible light by passive ultraviolet excitation according to claim 1, wherein said organic polymer is one selected from the collection of a silicone rubber, an optical polycarbonate (PC), an optical polymeric methyl methacrylate (PMMA) and an epoxy resin.

6. The light emitting module for producing a visible light by passive ultraviolet excitation according to claim 1, wherein said organic wavelength modulation material is one selected from the collection of a light emitting fluorene oligomer, a light emitting homopolymer and a light emitting copolymer.

7. The light emitting module for producing a visible light by passive ultraviolet excitation according to claim 1, wherein said quantum dot luminescence color rendering modulation material is one selected from the collection of CdSe, PbSe, CdS, PbS, core-shell quantum dots-CdSe/ZnS, a Group III/V semiconductor and a Group II/VI semiconductor.

8. The light emitting module for producing a visible light by passive ultraviolet excitation according to claim 1, wherein said nano particle size brightness enhancement luminescence powder is one selected from the collection of an oxide, a sulfide, a halogen calcium phosphate, a carbon, a diamond, an organic material and an inorganic material.

9. The light emitting module for producing a visible light by passive ultraviolet excitation according to claim 1, wherein said wavelength modulation matrix is formed by coating, injection molding, thin film lamination, screen printing or thick film printing.

10. The light emitting module for producing a visible light by passive ultraviolet excitation according to claim 9, wherein said wavelength modulation matrix is in the shape of a film layer, a bar, a sheet or a column.

11. The light emitting module for producing a visible light by passive ultraviolet excitation according to claim 1, further comprising a light guide module disposed at a position proximate to said excitation light source member for transmitting a light source emitted by said excitation light source member to the outside, and projecting said light source onto said wavelength modulation matrix, and said wavelength modulation matrix being mounted onto said light guide module by a thin film coating, a screen printing or a thick film printing.

12. The light emitting module for producing a visible light by passive ultraviolet excitation according to claim 11, wherein said light guide module and said wavelength modulation matrix are made from the same materials and integrated.

13. The light emitting module for producing a visible light by passive ultraviolet excitation according to claim 1, wherein said wavelength modulation matrix is mounted with an optical layer for evenly diffusing and directionally modulating a light source.

14. The light emitting module for producing a visible light by passive ultraviolet excitation according to claim 1, wherein said wavelength modulation matrix comprises a reflector installed in a direction opposite to the incidence of said ultraviolet light, for reflecting a light beam of said ultraviolet light source.
